(19) United States
(12) Patent Application Publication
(10) Pub. No.: US 2006/0177199 A1
(43) Pub. Date: Aug. 10, 2006

(54) Information recording medium, information reproducing apparatus, information recording method and reproducing method

(76) Inventors: Kazutoshi Horiguchi, Ome-shi (JP); Takero Kobayashi, Akishima-shi (JP); Yasufumi Tsumagari, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/351,396

(22) Filed: Feb. 10, 2006

(30) Foreign Application Priority Data
Feb. 10, 2005 (JP) 2005-034976

(51) Int. Cl. H04N 7/52

(52) U.S. Cl. 386/95

(57) ABSTRACT

A design is made for recording and arrangement of application data so as to stably control the behavior of moving picture data based on application data and easily achieve special reproduction of moving picture data. Therefore, moving picture data encoded in a preset format is multiplexed with application data used to control the behavior of a reproduced picture of the moving picture data. Further, the basic process is provided to deal with a first file which contains a multiplexed stream separated by preset units and a second file containing the same data as the application data.

### CROSS-REFERENCE TO RELATED APPLICATIONS

This application is based upon and claims the benefit of priority from Japanese Patent Application No. 2005-034976, filed Feb. 10, 2005, the entire contents of which are incorporated herein by reference.

### BACKGROUND

1. Field

One embodiment of the invention relates to an information recording medium, information reproducing apparatus, information recording method and reproducing method, becomes effective when this invention is applied to a Digital Versatile Disk (DVD) as an information recording medium, a reproducing apparatus and an information recording method, and can be applied to an information transmitting method.

2. Description of the Related Art

Recently, DVDs and recording and reproducing apparatuses thereof are popularly used. Further, high-definition DVDs whose recording capacity is increased have been developed. The DVD can be used not only for recording and reproducing moving picture data (which, in this example, includes video data, audio data, sub-video information and the like) but also for games applications.

Therefore, it is proposed that a personal computer having a DVD player or DVD drive is connected to the Internet and a game application is downloaded, for example. Then, an attempt is made to set the behavior of moving picture data recorded on the DVD in accordance with execution of the downloaded application.

As the technique for relating the DVD with the Internet without using the DVD in the closed state, Japanese Patent Document 1 (Jpn. Pat. Appn. KOKAI Publication No. 11-161663) is provided. In the Patent Document 1, the technique for storing a URL or the like in a navigation pack of video object units and displaying related Internet information by operating a button on the reproducing screen is disclosed.

When related information is acquired via the Internet, information provided via the Internet cannot always be stable. Further, there occurs a problem that it is not ensured that the contents which are optimum for moving picture data on the disk are acquired.

### BRIEF SUMMARY OF THE INVENTION

According to one embodiment of the invention, it is to provide an information recording medium, information reproducing apparatus and information recording method which perform the following processes. That is, the processes are (1) a process of recording application data which is optimum for moving picture data on a disk and stably controlling the behavior of a reproduced image of the moving picture data, (2) a process of paying much attention to the recording and arrangement of application data so as to simplify the operation of reproducing moving picture data in a specified fashion, and (3) a process of alleviating a useless access operation of a pickup so as to permit the reproduction operation to be stably performed.

In order to attain the above object, in the embodiment of the invention, moving picture data encoded in a preset format and application data which controls the behavior of a reproduced image of the moving picture data are multiplexed with each other and a first file containing a multiplexed stream separated by preset units and a second file containing the same data as the application data are dealt with as a basic operation.

According to the above means, application data which is optimum for moving picture data is recorded on the disk and the behavior of the reproduced image of the moving picture data can be stably controlled. Further, since the application data is also provided in a different file, the application can be prepared without fail at jump or skip reproduction time and the special reproduction of the moving picture data can be easily attained. That is, useless access operation of the pickup can be alleviated and the reproducing operation can be stably performed.

Additional objects and advantages of the embodiment will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing the basic hardware configuration of an information reproducing apparatus and information recording apparatus according to an embodiment of the invention;

FIG. 2 is an exemplary diagram showing basic function blocks of the software configuration used in the above apparatus according to the embodiment of the invention;

FIG. 3 is an exemplary diagram showing an example of the configuration of a multiplexed stream in the embodiment of the invention;

FIG. 4 is an exemplary flowchart for illustrating a procedure of configuring a multiplexed stream in the embodiment of the invention;

FIG. 5 is an exemplary diagram showing an example of function blocks used when the multiplexed stream in the embodiment of the invention is subjected to the demultiplexing process;

FIG. 6 is an exemplary diagram showing another example of function blocks used when the multiplexed stream in the embodiment of the invention is subjected to the demultiplexing process;

FIG. 7 is an exemplary flowchart for illustrating a data processing procedure when the multiplexed stream in the embodiment of the invention is subjected to the demultiplexing process;

FIG. 8 is an exemplary diagram showing one example of the characteristic portion of a multiplexed stream in the embodiment of the invention;

FIG. 9 is an exemplary diagram showing an example of function blocks used when the multiplexed stream shown in FIG. 8 is subjected to the demultiplexing process;

FIG. 10 is an exemplary diagram showing another example of the characteristic portion of a multiplexed stream in the embodiment of the invention and showing an example of function blocks used when the multiplexed stream is subjected to the demultiplexing process;

FIG. 11 is an exemplary diagram showing an effective utilization state of a multiplexed stream in the embodiment of the invention;

FIG. 12 is an exemplary flowchart showing another example of a data processing procedure when a multiplexed stream in the embodiment of the invention is subjected to the demultiplexing process;

FIG. 13A is an exemplary diagram showing the relation between a multiplexed stream in the embodiment of the invention and the DVD format;

FIG. 13B is an exemplary diagram showing the relation between a multiplexed stream in the embodiment of the invention and the DVD format;

FIG. 14 is an exemplary diagram showing one example of the relation between additional information contained in a multiplexed stream in the embodiment of the invention and the DVD format; and

FIG. 15 is diagram showing an example of the configuration of a DVD player to which the invention is applied.

### DETAILED DESCRIPTION

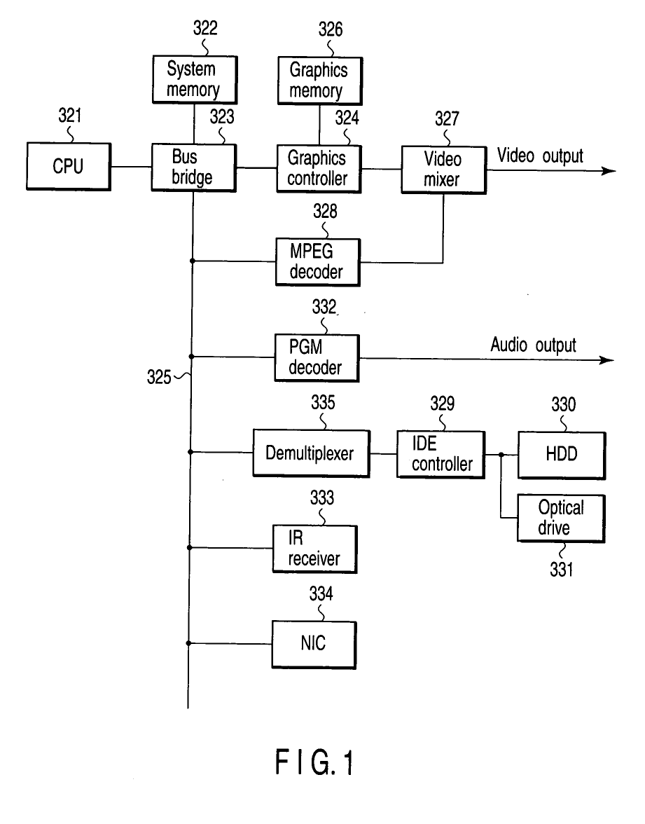

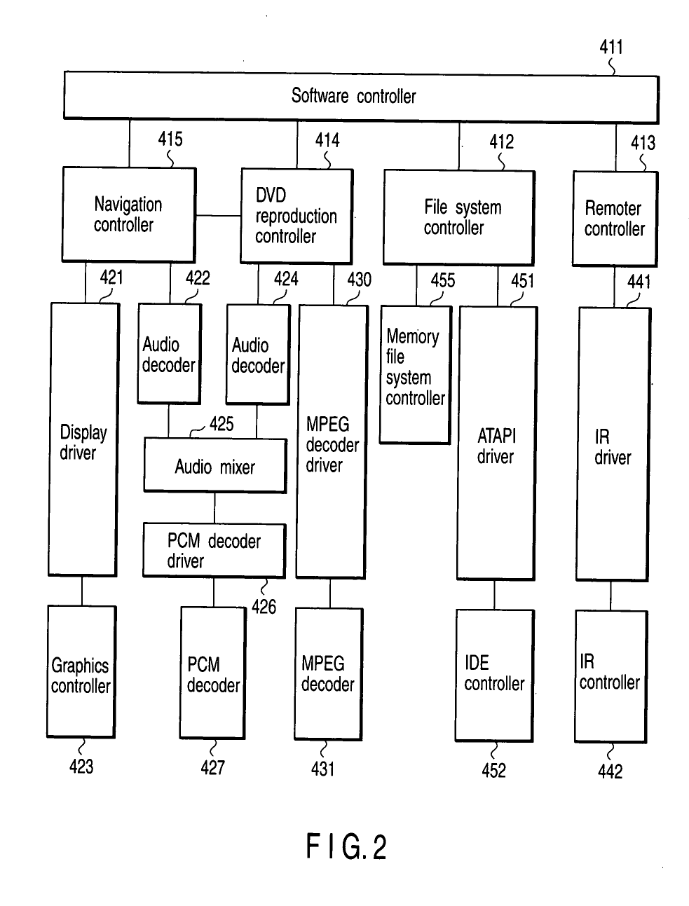

There will now be described embodiments of this invention with reference to the accompanying drawings. First, in FIGS. 1 and 2, the basic configuration of the hardware of an information reproducing apparatus and information recording apparatus to which this invention is applied and the basic configuration of a software which operates the above apparatuses are explained.

(Explanation for Basic Relation of Hardware)

The basic related configuration of hardware of an apparatus to which this invention is applied is shown in FIG. 1. A CPU 321 controls various devices connected to a system according to an execution program loaded on a system memory 322 and forms a picture image for graphics output.

A bus bridge 323 is connected to the CPU 321, system memory 322, graphics controller 324 and PCI bus 325 so as to control the data transfer process between the respective devices and the bus and perform the data relay control.

The system memory 322 is used to store a copy of an execution program stored in a hard disk drive (HDD) device 330 connected to an IDE controller 329, and used as a buffer area for storing variables required for calculation and data transfer.

The graphics controller 324 controls transfer of a picture image calculated by the CPU 321 from the system memory 322 to the graphics memory 326 and carries out the complicated image processing calculation of the process according to an instruction of the CPU 321. Further, it outputs image information to a video mixer 327 in synchronism with output timing of an MPEG decoder 328. That is, the graphics controller 324 includes a sync controller, frame formation omitting section, priority setting section and frame rate adjusting section.

The video mixer 327 subjects National Television System Committee (NTSC) signal information from the MPEG decoder 328 and image information from the graphics controller 324 to a superposition process. At this time, the superposition process is performed by using an α value in the image information output from the graphics controller 324 and an image signal is reproduced and output according to NTSC. The video mixer 327 includes an alpha blending section. Further, it includes a pixel processor which performs a synthesizing process at a pixel level.

The MPEG decoder 328 fetches MPEG2 data extracted from data read out from an optical drive 331 under control of the CPU 321, converts the same into image data and outputs the thus converted data to the video mixer 327.

A PCM decoder 332 periodically acquires pulse code modulation (PCM) data. The PCM data is obtained by converting data read out from the optical drive 331 based on calculation by the CPU 321. The PCM decoder 332 outputs an analog audio signal.

An IDE controller 329 is connected to the HDD device 330 and optical drive 331 to control the readout operation of data from the respective devices into a memory based on the control operation by the CPU 321. When data is read out from the disk, the data is subjected to a demultiplexing process by a demultiplexer 335.

The optical driver 331 is a DVD drive, for example, and reads out data from a DVD disk which stores data used to form a video plane and graphics plane.

The HDD device 330 stores an execution program to operate the present equipment. An IR receiver 333 controls reception of a signal from a remote controller which controls the present equipment. A network interface controller (NIC) 334 controls communication data used for connection with a network.

(Software and Function Block Configuration)

FIG. 2 shows the configuration of software and function blocks used in the apparatus to which this invention is applied. A software control section 411 is a module which controls the behavior of the whole portion of the software of this invention. It controls the operations of reading out data from a file system controller 412, receiving a user operation signal from a remote control receiver 413 and the operations of a DVD reproduction controller 414 which controls video reproduction and a navigation controller 415 which controls formation of a graphics frame and the like.

The navigation controller 415 forms an image used for navigation on the graphics frame by using navigation control data read out from the file system controller 412. Further, the navigation controller 415 controls the output timing of an image thereof based on time information of the DVD reproduction controller 414 via a display driver 421. It also controls an audio decoder 422 in order to output effective sound in accordance with a user event or the like.

The display driver 421 fetches graphics frame data formed in the navigation controller 415 and controls the graphics controller 423 to output graphics frame data. The audio decoders 422, 424 decode audio date supplied from the navigation controller 415 and DVD reproduction controller 414 and output the thus decoded data as PCM data to an audio mixer 425.

The audio mixer 425 superposes PCM data items input from the audio decoders 422, 424, converts the thus superposed PCM data into one PCM output data and outputs the data to the PCM decoder driver 426. The PCM decoder driver 426 supplies PCM data input from the audio mixer 425 to a PCM decoder 427 and controls audio reproduction.

The DVD reproduction controller 414 fetches DVD data read out via the file system controller 412, separates the data into video data, audio data and other data items and performs the respective reproduction control operations. An MPEG decoder driver 430 supplies MPEG data input from the DVD reproduction controller 414 to an MPEG decoder 431 and controls the operation of outputting data at adequate timings.

The remote controller 413 performs the process of interpreting an event of a remote control switch which is caused by an IR driver 441 and supplies information of the event as a message to the software controller 411. The IR driver 441 controls interruption by the IR controller 442, detects what one of the remote control switches is depressed and informs the remote control driver of the detected switch type.

The file system 412 manages the file system on the optical drive device and HDD device. An ATAPI driver 451 is controlled by the file system controller 412 and controls an IDE controller 452 to read out data from the optical disc drive device and HDD device. A memory file system controller 455 controls a memory, hard disc and the like which store application data items.

(Basic Concept of Multiplexed Stream used as Prerequisite of Present Invention)

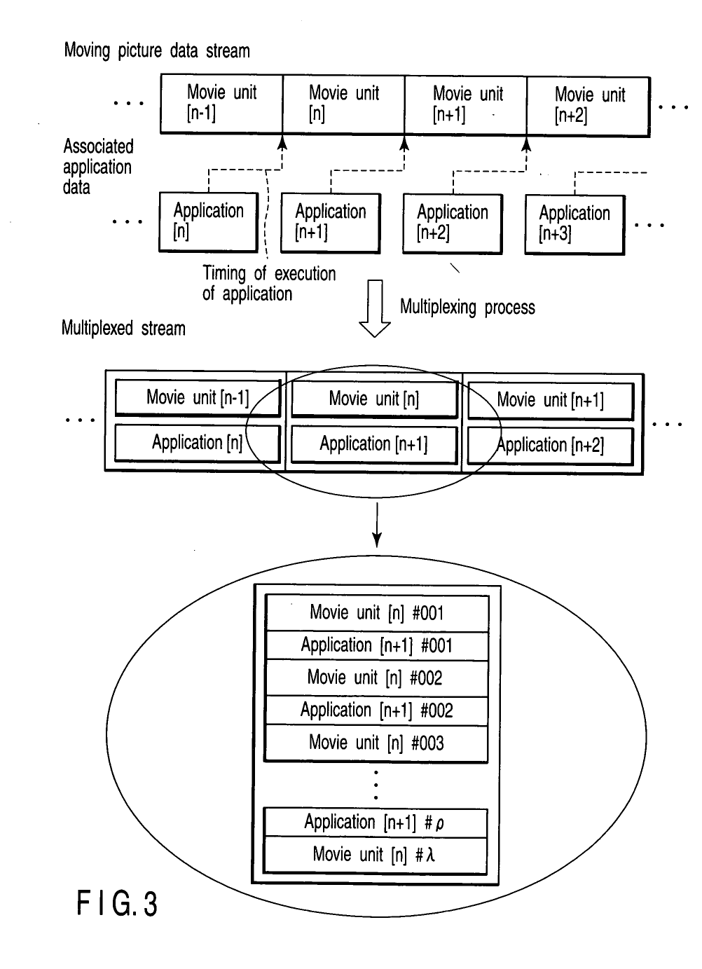

First, the basic concept of the data structure used as the prerequisite of this invention is explained. As shown in FIG. 3, moving picture data stored in a DVD is formed as a plurality of picture units (which may be referred to as movie units) which are each used as a reproduction unit and the moving picture can be viewed by sequentially and continuously reproducing the units. In the conceptual diagram of FIG. 3, the reproduction unit is expressed by movie units (Movie Unit) (n).

Further, application data associated with reproduction start of the movie unit (n) is expressed by application (n). That is, the application (n) is used to control the behavior of the moving picture reproduced by the movie unit (n). In this case, n is a parameter indicating a time series and is a value which increases as the reproducing operation proceeds.

In this embodiment, a data multiplexing method which deals with video information/application data as one data is proposed.

As shown in FIG. 3, the multiplexing process is to multiplex an application (n) used in a next movie unit (n) with a movie unit (n−1). This is because it is necessary to previously read out the application and make preparation for the next movie unit. That is, the above process is performed to set up a state in which the CPU can execute an application (n+1) (all of the data items have been acquired) by the time the movie unit (n+1) has started to be reproduced. Since the application (n+1) is executed at a desired timing in a time period from the reproduction start time of the movie unit (n+1) to the reproduction start time of the movie unit (n+2), it is necessary to acquire all of data items of the application (n+1) before the reproduction start time thereof. Therefore, the application (n+1) is multiplexed in a position of the reproduction unit existing before the movie unit (n+1).

In the example of FIG. 3, the data structure is shown in which movie units (n) #001 to #00n and applications (n+1) #001 to #00n are alternately arranged in such a form that an application (n+1) #001 is inserted between a movie unit (n) #001 and a movie unit (n) #002 for each information unit as an example.

(Flowchart of Multiplexing Process)

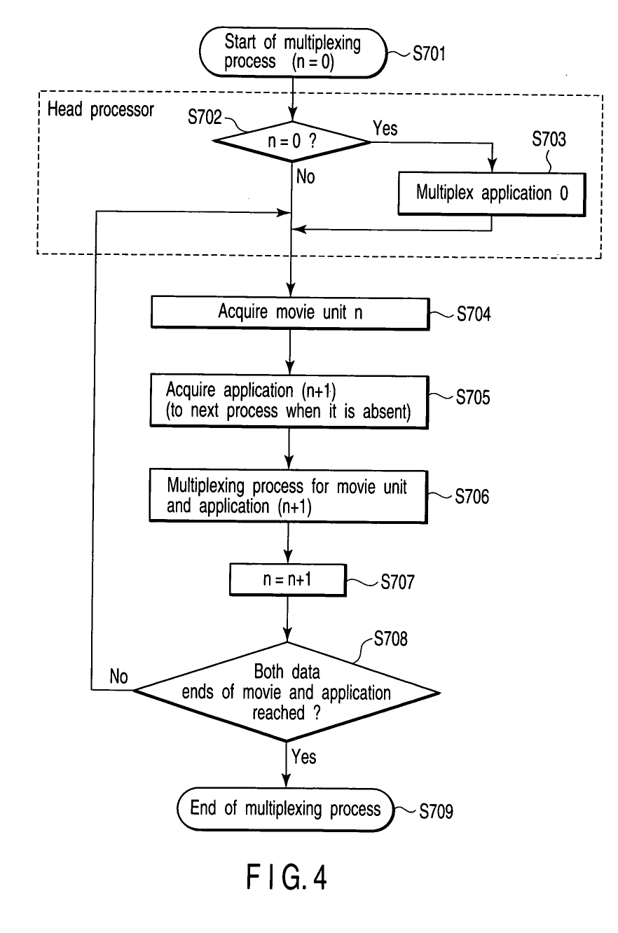

FIG. 4 shows a procedure at the time of a multiplexing process. The multiplexing process is started based on the operation program of the multiplexing process and the time series parameter n of the moving picture data stream and associated application stream is set to zero (step S701). Then, whether it is immediately after the multiplexing process is started or not is determined (step S702). If it is immediately after the multiplexing process is started, the multiplexing process for the application (0) is executed (step S703).

Further, in the multiplexing process after n=1, a video unit (n) which is used as an object of the multiplexing process is acquired (step S704) and then an application (n+1) is acquired (step S705). At this time, if the application (n+1) is not present, that is, if it is not necessary to execute any application at the reproduction start time of the video unit (n+1), a process of acquiring an application is not performed.

In this case, a difference between the time series of the video information and the time series of the application information is preferably set so that the application information will precede the video information. However, the above time series relation is not necessarily set and the multiplexing process can be preformed even if the time series of the video information and the time series of the application information are set to the same. Further, a difference of 5 or 10 between the time series of the video information and the time series of the application information can be set.

Next, the multiplexing process for the video unit (n) and application (n+1) thus acquired is performed (step S706). As described above, at the multiplexing time, the video unit (n) and application (n+1) are divided and multiplexed. More specifically, the read rate required by the video information and application information is set to a value which does not reach the reproduction rate of 10.08 Mbps or more as an example. For example, in the multiplexing section of the information recording apparatus, the amount of application information is calculated and application information is inserted into between video units (a plurality of video/audio information items=control information/video information/audio information or the like) according to the thus calculated information amount.

Further, insertion of application information into between video units (a plurality of video/audio information items=control information/video information/audio information or the like) can be made in various forms. For example, it is the form of VOBU unit or pack unit. This is explained in detail later with reference to the accompanying drawings.

Next, after the video unit (n) and application (n+1) are multiplexed, a time series parameter (n) is added and a to-be-processed object is changed to next video information (step S707). The multiplexing process is performed until the data end of each information (step S708), and when a multiplexing process for all of the main video streams and application streams comes to an end, the multiplexing process is completed (step S709).

The data stream having the multiplexed data structure is recorded in a recording area of a recording medium D such as a DVD via an optical disk drive section, for example. However, it is also possible to perform the recording process on the recording medium while the multiplexing process is being performed.

In the present embodiment, for example, a case wherein the recording process of the DVD recording and reproducing apparatus is performed is explained. However, in an authoring system to manufacture a DVD-ROM having substantially the configuration as that of the DVD recording and reproducing apparatus, the multiplexing process can be performed in the same fashion.

The apparatus which forms the multiplexed stream is configured by an editing section and encoder section of the DVD recording apparatus.

(Explanation and Problem of Demultiplexing)

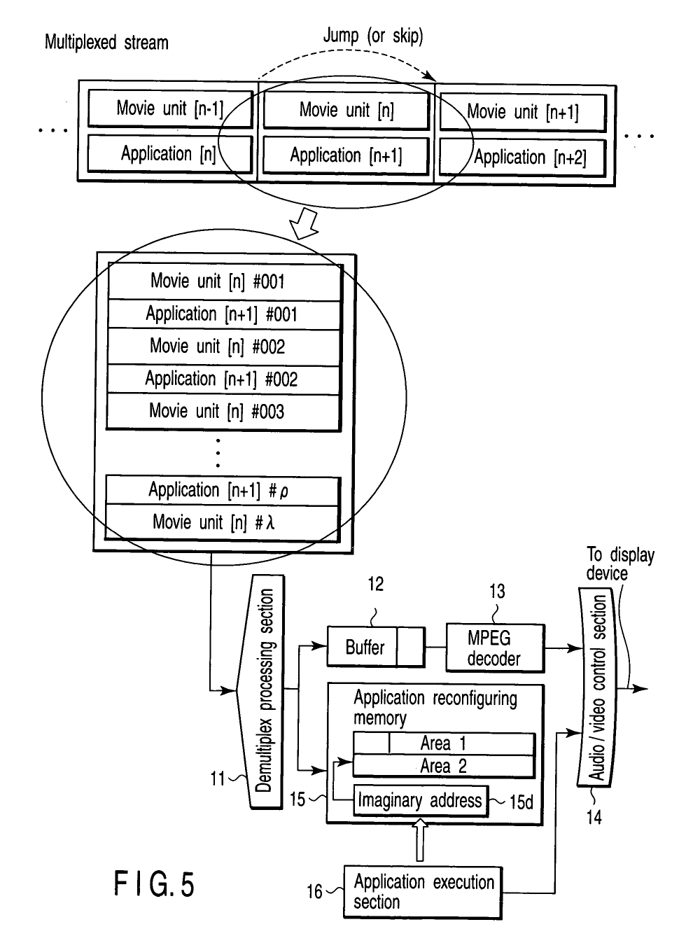

FIG. 5 is a conceptual diagram showing an example in which the multiplexed stream is subjected to the demultiplexing process. The multiplexed stream is input to a demultiplex processing section 11. Now, it is assumed that a portion of the multiplexed stream which is encircled in the drawing is subjected to the demultiplexing process. In the demultiplex processing section 11, a movie unit and application unit are separated from each other. As marks for unit separation, for example, identification information items are described in headers of the movie units and application units and unit separation can be carried out by referring to the identification information items. Moving picture data in the separated movie unit is input to a buffer 12. Moving picture data read out from the buffer 12 is input to and decoded by an MPEG decoder 13 and output as digital moving picture baseband data. The digital moving picture data is input to an audio/video control section 14 which in turn supplies an output signal as an analog video signal to a display.

On the other hand, application data contained in the application unit is input to a memory 15 for application reconfiguration. In this example, application information corresponding to the moving picture data is already stored in the memory. Further, application data for a unit next to moving picture data which is now read out is reconfigured. The application data stored at present is analyzed by an application execution section 16 which in turn supplies a command used to execute the application to the audio/video control section 14. Thus, the moving picture data behaves based on the application and is supplied to the display. For example, an audio output based on the application is obtained, synthesis display of graphics data based on the application is obtained or the like.

In this case, it is assumed that an area 2 is secured in the memory 15 and application data stored in the area 2 is now used. In the memory 15, an area 1 is also secured. The area 1 is used to store and reconfigure an application utilized when moving picture data of a next movie unit is reproduced.

Thus, when the multiplexed stream is sequentially reproduced without interruption, an application can be executed without causing any problem.

However, a problem occurs when a jump performance is done and the movie unit n+1 is reproduced after the movie unit n−1 was reproduced. That is, this is because the application which determines the behavior of the movie unit n+1 is recorded in an area from which information is not read out for the above jumping operation. In this case, it becomes impossible to correctly control the moving picture of the movie unit n+1.

In FIG. 5, for simplifying the explanation, portions corresponding to those of FIGS. 1 and 2 are shown in a simplified form. In practice, the demultiplexer 335 of FIG. 1 corresponds to the demultiplex processing section 11 and the other blocks of FIG. 1 are representatively expressed by the buffer 12, MPEG decoder 13 and audio/video control section 14.

(Means for Securely Acquiring Application Data)

In order to solve a problem that the moving picture cannot be correctly controlled, the apparatus of this invention has the following measures.

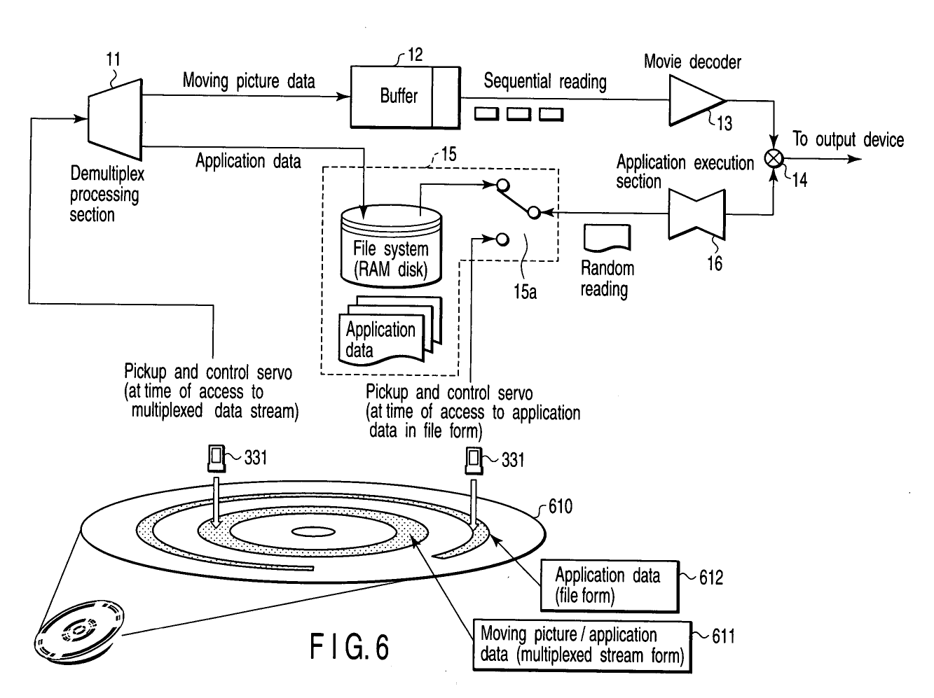

In FIG. 6, portions corresponding to the function blocks of FIG. 5 are denoted by the same reference symbols as those of FIG. 5. That is, as schematically shown in FIG. 6, application data 612 of a file form is recorded in addition to a multiplexed stream 611 explained before on an optical disk 611 in this invention. Therefore, when the application n corresponding to the moving unit n does not exist in the memory 15, the application execution processing section 16 changes the switching position of the switch 15a, directly acquires the application data 612 recorded in the file form from the optical disk 610 and utilizes the same.

Like the case of FIG. 5, in FIG. 6, for simplifying the explanation, portions corresponding to those of FIGS. 1 and 2 are shown in a simplified form. In practice, the demultiplexer 335 of FIG. 1 corresponds to the demultiplex processing section 11 and the other blocks of FIG. 1 are representatively expressed by the buffer 12, MPEG decoder 13 and audio/video control section 14.

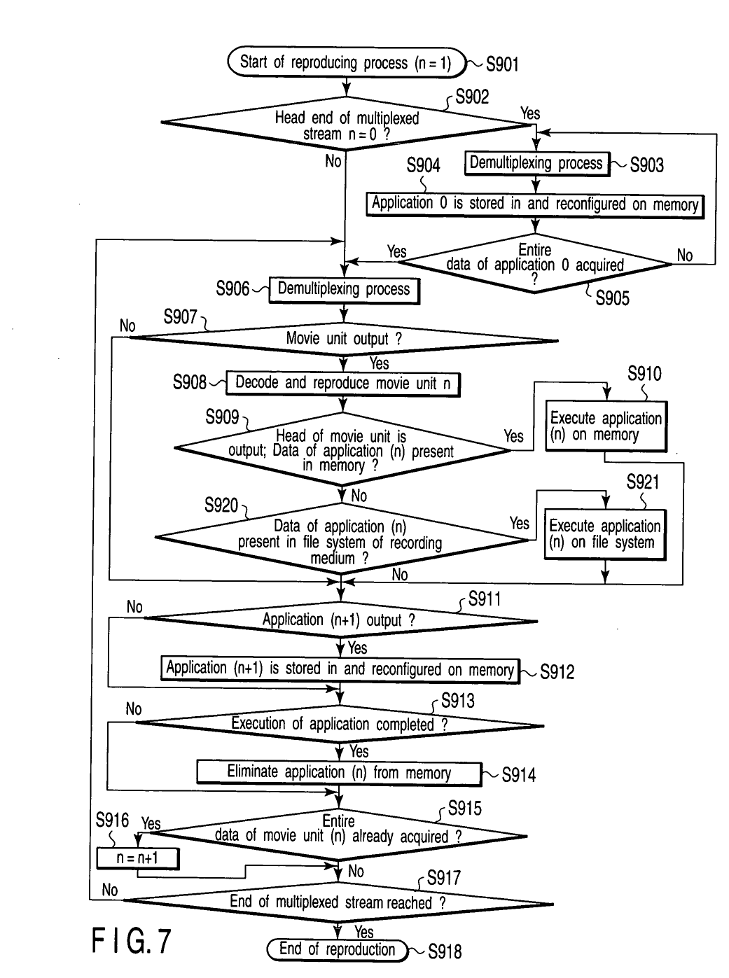

FIG. 7 is a flowchart for illustrating an operation performed when a special reproduction process such as a chapter jump or skip process is performed during the reproducing process.

For example, when the reproducing process is started, header information of the unit of a reproduction signal is checked to determine whether or not it is the head end of the multiplexed stream. If it is the head end, the demultiplexing process is performed (steps S901, S902, S903, S904, S905). Thus, data of the application (n=0) is stored in and reconfigured on the memory 15.

After this, the demultiplexing process is further performed, whether a movie unit (n) is acquired or not is determined (steps S906, S907) and the movie unit (n) is decoded and reproduced (S908). In this case, the head of a reproduced output of the movie unit (n) starts to be output, and at the same time, whether the application (n) corresponding to the movie unit (n) exists in the memory 15 or not is determined (S909). When the application (n) exists, the behavior of the moving picture is controlled by executing the application (steps S910, S921).

If it is determined in step S909 that the application (n) corresponding to the movie unit (n) does not exist in the memory 15, the following operation is performed. At this time, the process proceeds to step S920 to determine whether or not data (file) of the application (n) exists on the file system of the recording medium. This can be easily determined by recognizing file identification information of a route directory previously read out into the work memory at the disk loading time. When data (file) of the application (n) exists on the file system of the recording medium, the application is utilized and executed (S921).

When it is determined that data (file) of the application (n) does not exist on the file system in the determining process of the step S920 after the process of step S921 was executed, the process proceeds to step S911.

In step S911, whether or not a next application (n+1) starts to be reproduced is determined. If the next application starts to be reproduced, the application (n+1) is stored in and reconfigured on the memory 15 (step S912). In the next step S913, whether execution of the application (n) is completed or not is determined. If the execution is completed, the application (n) is omitted from the memory 15 (step S914). If the execution is not completed, whether acquisition of all of data of the movie unit (n) is completed or not is determined (step S915).

When acquisition of all of data of the movie unit (n) is completed, n is incremented by +1 (n=n+1) in order to acquire a next unit (step S916) and the process proceeds to step S917. In this case, whether the terminal end of the multiplexed stream is reached or not is determined. If it is determined to be the terminal end, the reproduction process is ended in step S918 and if it is determined not to be the terminal end, the process returns to step S906.

As described above, application data with the same contents is provided on a file different from the file on the multiplexed stream. Therefore, when a chapter jump or skip occurs during the reproducing process and if part of the application data cannot be acquired, application data of a different file can be utilized to attain the smooth reproduction operation. Further, as described above, application data is provided in a different file form, and therefore, it is only required to carry out the file search process and data-in-file expansion process. Thus, access time can be shortened and the chapter jump or skip function used as a performance can be easily designed.

Further, even when fatal defects occur due to scratches and stains on the disk and multiplexed application data cannot be acquired, the ability of covering the above accident can be attained since the application data is provided in a different file form.

(Effective Utilization of Header Information of Movie Unit) and (Description of Existing Position Information of Application Data)

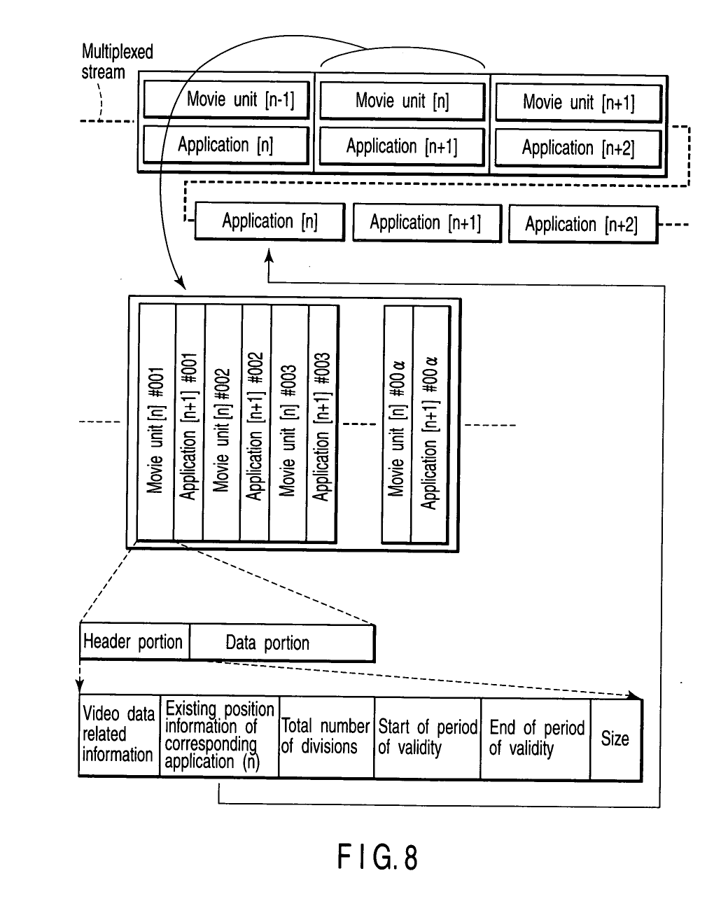

FIG. 8 shows another embodiment of the data structure in this invention. In the previous embodiment, when a jump or skip occurs, it is determined on the file system whether or not an application corresponding to the movie unit exists on the file system. However, this is not limitative and, for example, existence of the corresponding application may be positively described in data of the movie unit.

That is, as shown in FIG. 8, an application (n+1) utilized for the next movie unit (n+1) is multiplexed with the movie unit (n) in the multiplexed stream. Therefore, in order to permit the movie unit (n) to behave based on the application, it is necessary to reconfigure the application (n) multiplexed with the preceding movie unit (n−1). However, when a jump or skip occurs, a case wherein the application (n) is not structured in the memory 15 occurs in some cases.

In the present embodiment, information associated with the corresponding application (n) in addition to additional information (such as attribute information, control information or the like) for video data is described in the header portion of the movie unit (n). For example, existing position information of corresponding application, total number of divisions of application, period-of-validity start information of application, period-of-validity end information of application, data or file size of application and the like are provided.

Existing position information which is recorded in an independent file form on the optical disk is described in the application (n) corresponding to at least the movie unit (n). Since the application data is smaller in amount than video data, the application data does not consume the disk capacity so much even if it is multiplexed with the movie unit and the same application data is independently described in a different file.

The header portion may be a control pack portion, for example. As the contents of description of additional information, attribute information of the application data file is provided. Further, the file name, storage position, file size, file type, compression form or the like may be described. The file name is a file name on the file system of the recording medium. The storage position is the type or position of the recording medium. For example, when a plurality of recording medium readout devices are attached to the recording and reproducing apparatus, a drive letter of the readout device, information of the sector position and uniform resource identification (URI) in the case of using a network are specified. As the file type, a tag file of HTML, a script of text base of JavaScript or the like can be used, for example.

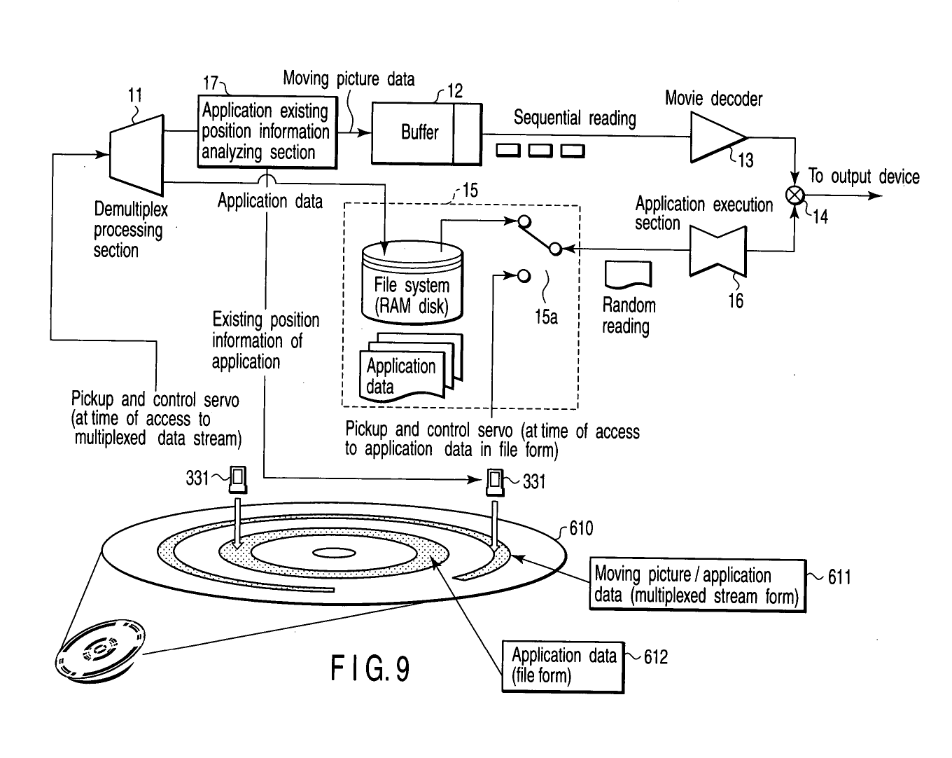

As shown in FIG. 9, with the above data structure, it is necessary to analyze the header portion of the movie unit obtained from the demultiplex processing section 11. Therefore, an application existing position information analyzing section 17 is provided between the demultiplex processing section 11 and the buffer 12. In this section, the existing position information of the application corresponding to the movie unit which is now reproduced is acquired. For example, while a jump or skip operation is being performed, application existing position information is automatically used. Then, application data recorded in a different file on the optical disk 610 is acquired by use of the pickup 331. The other portions are the same as those of FIG. 6 explained before.

(Effective Utilization of Header Information of Application Unit)

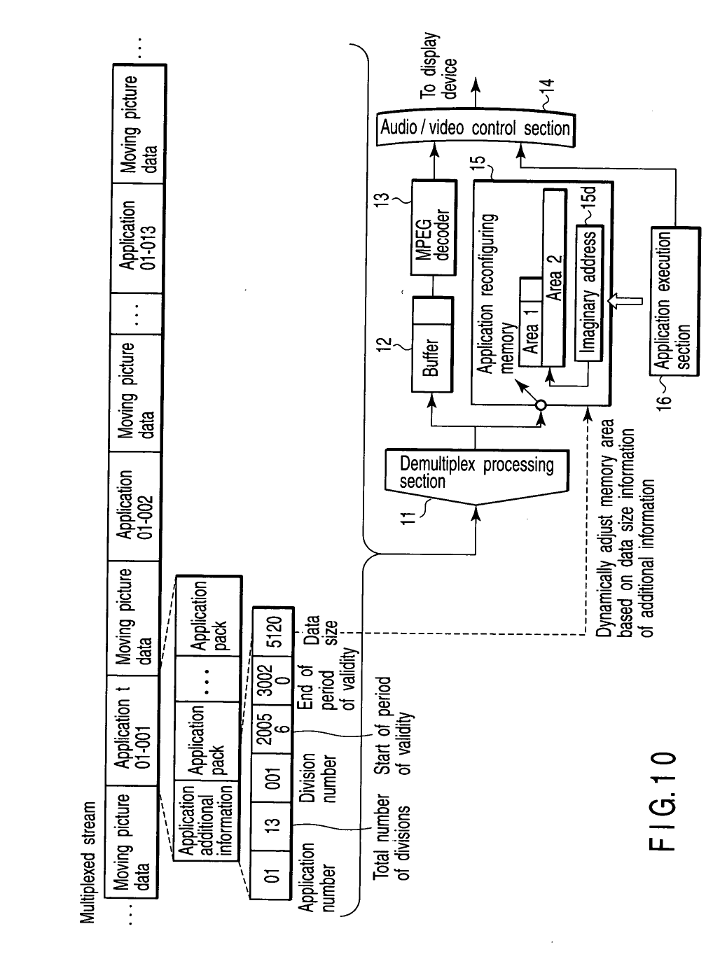

FIG. 10 shows another embodiment of the data structure in this invention. In a multiplexed stream, a state in which moving picture data and application are multiplexed with each other is shown. For example, one application 01 is divided into applications 001 to 013 which are interleaved with moving picture data items. In this case, as the header of the application data, application adding information exists. In the application adding information, an application number (01), total number of divisions (13), the division number (001 in the example of FIG. 10), period-of-validity start information (20056 in the example of FIG. 10), period-of-validity end information (30020 in the example of FIG. 10), data size information (5120 in the example of FIG. 10) are contained.

If the data size information is thus contained, an advantage that the storage area of the application data can be dynamically controlled in the memory 15 is attained. That is, the memory 15 can be effectively used. This becomes effective when period-of-validity information which will be described later is used.

The utilization method of the memory 15 is additionally explained. The application execution processing section 16 reproduces a movie unit and, at the same time, executes an application while referring to corresponding application data. It transfers audio/video data formed at this time to the audio/video controller 14. Then, it eliminates application data which becomes unnecessary at the same time as termination of the application (based on period-of-validity end information) from the memory 15. In the memory 15, two areas of size corresponding to at least twice the maximum size of the application data unit are secured. When data which is now executed is stored in one of the areas, the other area is used to store and reconfigure application data which is now reproduced and acquired.

Further, an imaginary address 15d is prepared. The application execution processing section 16 is set to execute the application via the imaginary address 15d, for example. Therefore, even if application data to be executed is stored in the area 1 or 2, the application execution processing section 16 can continuously execute the application irrespective of the storage position thereof. The imaginary address 15d is set to selectively specify one of the areas in which executable application data is stored.

(Effective Utilization of Header Information of Application Unit: Effective Utilization of Validity Period)

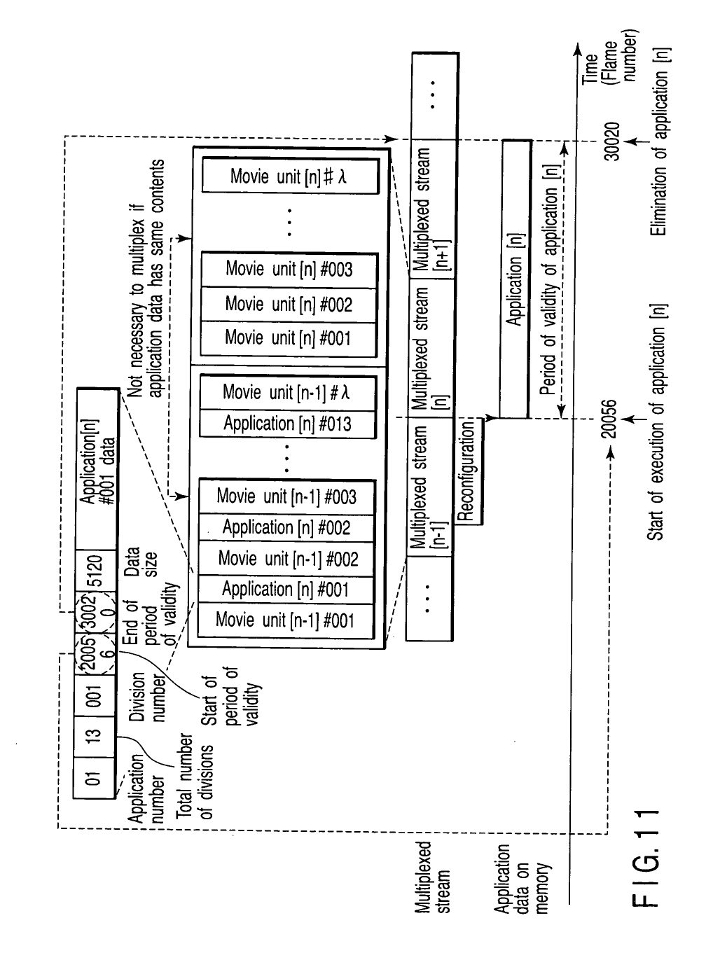

FIG. 11 shows the effect obtained when period-of-validity start information and period-of-validity end information are utilized. When period-of-validity start information and period-of-validity end information are added to application data, a period in which the application data is kept stored can be set in the memory 15. When it is desired to use application data of the same contents plural times in different movie units (for example, n-th and (n+1)th movie units), the application (n) configured at the time of reproduction of the (n−1)th movie unit may be kept held until the multiplexed stream (n+1) is reproduced. In the example of FIG. 11, the application (n) becomes valid at the time 20056 and is kept held until the time 30020. The movie units (n) and (n+1) are reproduced in a period from the time 20056 to the time 30020 and the behavior thereof is realized by use of the same application. For example, it is not necessary to multiplex data items plural times by simply holding the same application when the same effective sound and a scene of the same graphics video image are obtained.

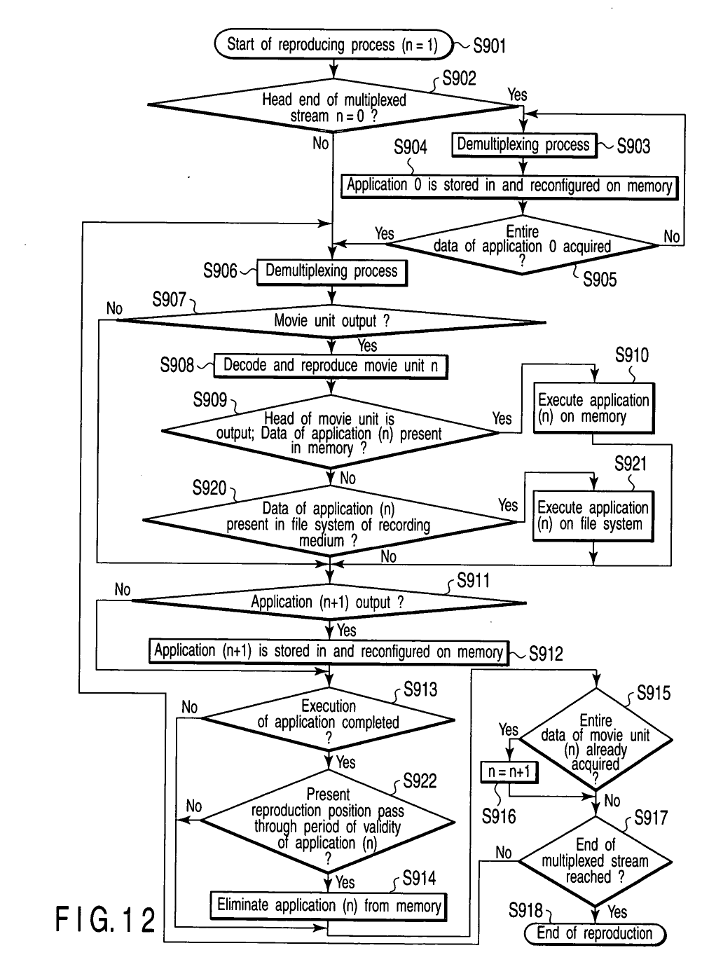

FIG. 12 is a flowchart for illustrating the operation of the apparatus when the function of utilizing the period-of-validity start information and period-of-validity end information is added. The flowchart is the same as the flowchart shown in FIG. 7 except that step S922 is additionally provided between steps S913 and S914. In step S922, whether or not the present reproduction time has passed through time defined by the period-of-validity end information of the application data held in the memory is determined. If the period-of-validity end time has been passed through, the application data is eliminated.

(Modification of Additional Information and Multiplexed Stream)

In the above explanation, the movie unit and application are multiplexed with each other in the multiplexed stream. A case wherein the behavior of the reproduced image can be obtained without reading out the application unit of another file in the successive reproduction process is explained.

However, in this invention, (1) as factors multiplexed in the multiplexed stream, only the movie units and additional information items for the applications (for example, existing position information, application number, total number of divisions, the division number, period-of-validity start information, period-of-validity end information, data size information and the like described in the header) may be described. Therefore, in the actual application data, all of the data items may be provided as a different file. Further, (2) as factors multiplexed in the multiplexed stream, application data is also multiplexed as explained in the above embodiment. However, application data to be supplemented may be described as a different file. In this case, the application data of the different file is not always used, particularly, when the jump or skip operation is performed. That is, at the successive reproduction time, the application data of the different file can be used for each supplementation and the application can be upgraded. Further, (3) for example, an application of a different file can be previously prepared by additionally providing preparation start time information as the period-of-validity information. That is, when an application is fetched via the Internet, for example, or when the application is fetched from another piece of equipment, previous preparation time is required. Therefore, previous preparation application information can be multiplexed with a movie unit which precedes reproduction of a movie unit to be utilized and the application can previously be stored in the memory 15 (or hard disk) with a margin of sufficiently long time.

(Example of Application to DVD Format)

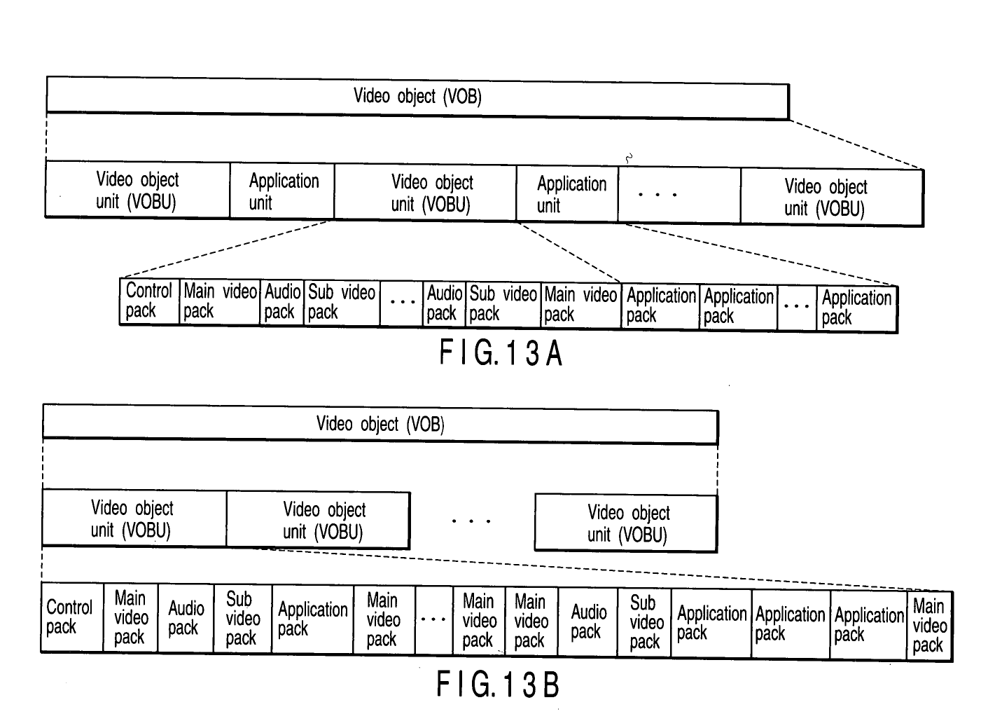

In the above explanation, the multiplexed stream is explained in the form of the movie units and application units. Next, a case wherein the multiplexed stream is associated with the DVD format is explained. As shown in FIG. 13A, as the form of the multiplexed stream, a format is provided in which application units are respectively multiplexed between a plurality of video object units (VOBU) contained in a video object (VOB). The video object unit (VOBU) and application unit are configured by packs based on the DVD standard. Alternatively, as shown in FIG. 13B, a plurality of video object units (VOBU) are contained in the video object (VOB). The video object unit (VOBU) also contains a control pack (navigation pack), main video pack, sub-video pack and audio pack and an application pack can be multiplexed together with the above packs.

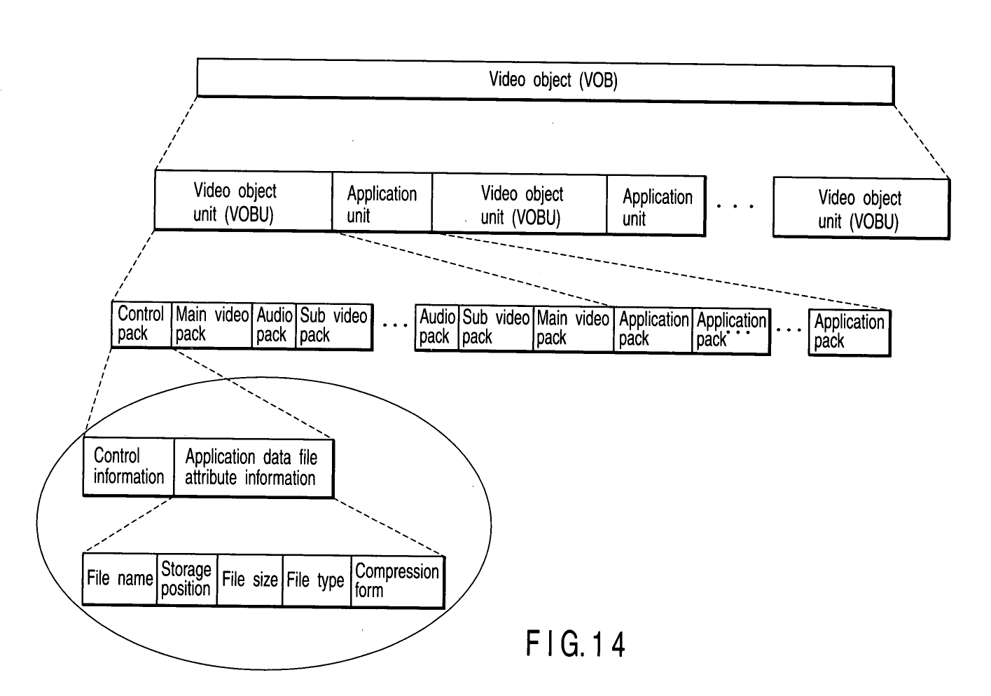

FIG. 14 shows one example in which attribution information of the application is added as additional information in the control pack (navigation pack) in the video object unit (VOBU). In this example, for example, information items such as the file name, storage position, file size, file type and compression form are used.

(Configuration of DVD Player)

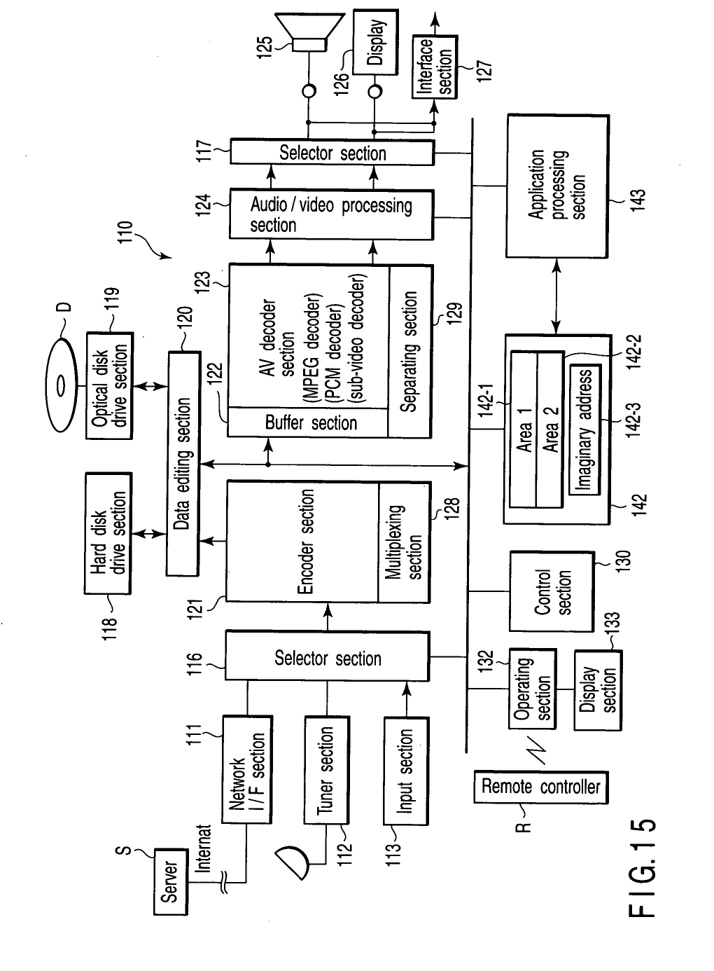

FIG. 15 shows a concrete example of the DVD player to which this invention is applied.

The recording and reproducing apparatus includes two types of disk drive sections. First, an optical disk drive section 119 rotates and drives an optical disk D as a first medium to read out and write information. A hard disk drive section 118 drives a hard disk as a second medium.

Further, the apparatus includes an encoder section 121 configuring the recording side, an MPEG decoder section 123 configuring the reproducing side, and a control section 130 which controls the operation of the main body portion of the apparatus as the constituents. The control section 130 is connected to various function blocks via the data bus to control the whole portion of the apparatus.

(Drive System)

Under control of the control section 130, the optical disk D rotated at preset speed is applied with laser light from the optical head, the reflected light therefrom is detected by an optical pickup and a detection signal corresponding to the reflected light is obtained. An RF signal is formed based on the detection signal and a data demodulation and reproduction process is performed. Further, a focus tracking servo signal is obtained based on the detection signal. The recording process with respect to the optical disk is performed under control of the control section 130 by supplying a drive current of the laser driver to the laser light source of the optical head to apply a laser beam to the storage area of the optical disk D according to an encoded output from the data editing section 120 and an output of the control section 130.

(Encode System)

A selector section 116 on the input side of the recording and reproducing apparatus is connected to a network interface section 111, tuner section 112 and input section 113 and the selector section 116 outputs a selected signal to the encoder section 121. The encoder section 121 encodes an input signal into a preset format based on the DVD standard together with a multiplexer section 128 and outputs the thus encoded data to the data editing section 120. Although not shown in the drawing, the data editing section 120 includes a data processing section and multiplexes management information from the control section 130 and application data which will be described later to output a multiplexed stream to the drive section 118 or 119. Further, in the data processing section, a function of the process of adding an error correction code with respect to recording data and a function of code conversion (so-called modulation process) are contained.

Further, in the data editing section 120, the editing process of partly eliminating video objects of plural programs recorded on the hard disk drive section 118 or optical disk D or connecting objects of different programs can be performed.

At the time of the editing process or at the time of other processes, the contents to be informed to the user among the execution results of the micro processor unit (MPU) are displayed on a display section 133 of the recording and reproducing apparatus or displayed in an on-screen display (OSD) fashion on a display 126.

For example, the network interface section 111 is connected to a server S via the Internet or the like to download the contents information or the like. The tuner section 112 selects a broadcast signal via the antenna and demodulates the reception signal to obtain a video signal and audio signal. For example, signals of terrestrial analog broadcasting, terrestrial digital broadcasting, DBS analog broadcasting, DBS digital broadcasting and the like can be received. Further, for example, two, three or more tuner sections for terrestrial analog broadcasting may be provided and can be operated in parallel according to a request of setting for picture recording. The input section 113 receives a video signal and audio signal of a composite signal, luminance signal or color-difference signal from the exterior.

The above signals are controlled by a selector 116 which is controlled by the control section 130 and selectively supplied to the encoder section 121.

(Decode System)

A reproduction signal from the hard disk drive section 118 or optical disk drive section 119 is input to the data editing section 120. In this case, the demodulation process and error correction process of the reproduction signal are performed. A demodulation output from the data editing section 120 is input to a buffer section 122.

The demodulation output of the buffer section 122 is separated in the packet unit in a separation section 129 and input to an audio/video (AV) decoder section 123. The AV decoder section 123 includes an audio decoder and video decoder and an output thereof is input to an audio/video processing section 124. In the audio/video processing section 124, the audio signal and video signal are subjected to an amplification process and quality adjusting process, then subjected to a digital-analog conversion process and supplied to a speaker system 125 and display 126 via a selector section 117. As the video signal, a sub-video signal is also provided, but the system thereof is omitted here. That is, the AV decoder section 123 has a video processor which adequately synthesizes the decoded sub image with the decoded main image to superpose a menu, highlight button, subtitles and other sub images on the main image and output the thus superposed data.

The selector 117 is also connected to an interface section 127 so as to communicate with the exterior. Thus, processed data can be transferred to the external equipment via the interface section 127. As a result, the selector section 117 can directly select a signal which has passed through the encoder section 121 when a digital signal from the TV tuner 112 or input section 113 is directly monitored.

(Operation System)

The user can perform the power supply ON-OFF operation of the apparatus and the recording, reproducing and special reproducing (skip, still formation) operations by the apparatus by operating the remote controller R. An operation signal of the remote controller R is transmitted to an operating section 132 with infrared rays used as a medium, for example. The operation contents of the received signal obtained by the operating section 132 is analyzed by the control section 130 and the control section 130 performs the sequence control operation and various function block setting operation based on the result of analysis. The operation state based on the operation result and the present state of the apparatus are displayed on the display section 133 and stop, reproduction, picture recording, special reproduction, reproduction time, picture recording time and the like are displayed.

(Basic Portion Operated based on Application)

A memory portion 142 is connected to the bus. The memory portion 142 includes a first area 142-1, second area 142-2 and imaginary address portion 142-3. The memory portion 142 can be secured in an area of the hard disk of the hard disk drive section 118. The memory portion 142 is managed and accessed by an application processing section 143.

(Recording Method applied to Above Apparatus)

The above apparatus includes an information recording apparatus which includes encoders 121, 128 which encode input moving picture data in a preset format, recording means 118, 119, 120 for recording encoded moving picture data output from the encoders into a recording medium, and the control section 130 which generally controls the operations of the encoders and recording means. The information recording method is to multiplex the encoded moving picture data with an application used to control the behavior of the reproduction image of the encoded moving picture data by use of the encoders and control section and record a first file containing a multiplexed stream separated in the preset unit. In addition, a second file containing the same data as the application data is recorded by use of the control section and recording means. Further, in the control section 130, information indicating the period of validity of corresponding application data is contained in additional information of the header of the application data which is multiplexed in the first file.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information recording medium comprising:
a first file which contains a multiplexed stream separated by preset units and in which moving picture data encoded in a preset format is multiplexed with application data used to control behavior of a reproduced image of the moving picture data, and
a second file containing the same data as the application data.

2. The information recording medium according to claim 1, wherein a header is added to the application data which is multiplexed in the first file and information indicating a period of validity of corresponding application data is contained as additional information in the header.

3. The information recording medium according to claim 1, wherein a header is added to the multiplexed moving picture data and existing position information of corresponding application data in the second file is described as additional information in the header.

4. The information recording medium according to claim 2, wherein the additional information contains information of size of corresponding application data in the second file.

5. The information recording medium according to claim 1, wherein the moving picture data is stored in a pack string, the application data in the first file is also stored in a pack string and the pack strings are interleaved.

6. The information recording medium according to claim 1, wherein the moving picture data is stored in a pack string and arranged in a first object unit, the application data in the first file is also stored in a pack string which is arranged in a second object unit and the first and second object units are interleaved.

7. An information reproducing apparatus comprising:
an information recording medium which records a first file which contains a multiplexed stream separated by preset units and in which moving picture data encoded in a preset format is multiplexed with application data used to control behavior of a reproduced image of the moving picture data, and a second file containing the same data as the application data,
demultiplex processing means for demultiplexing the multiplexed stream data into moving picture data and application data,
storage means for storing application data, and
read means for reading application data in the second file with reference to additional information contained in the stream in the course of reproduction of the multiplexed stream and supplying the readout data to the storage means.

8. The information reproducing apparatus according to claim 7, further comprising means for deciding execution and elimination of application data stored in the storage means based on a period of validity when information indicating the period of validity of corresponding application data is contained in the additional information of the header of the application data.

9. The information reproducing apparatus according to claim 7, wherein existing position information of corresponding application data of the second file is described in additional information of the header of the multiplexed moving picture data, and the read means reads application data of the second file based on the existing position information and supplies the readout data to the storage means.

10. An information recording method of an information recording apparatus which includes an encoder which encodes input moving picture data into a preset format, recording means which records encoded moving picture data output from the encoder on a recording medium, and a control section which controls the operations of the encoder and recording means, comprising:
recording a first file which contains a multiplexed stream separated in preset units and in which the encoded moving picture data is multiplexed with application data used to control behavior of a reproduced image of the encoded moving picture data by use of the encoder and control section,
recording a second file containing the same data as the application data by use of the control section and recording means, and
permitting information indicating a period of validity of corresponding application data to be included in additional information of a header of the application data multiplexed in the first file by use of the control section.

11. The information recording method according to claim 10, wherein the control section adds a header to the multiplexed encoded moving picture data and describes existing position information of corresponding application data of the second file as additional information in the header.

12. The information recording method according to claim 10, wherein the control section sets information of size of corresponding application data of the second file in the additional information.

13. The information recording method according to claim 10, wherein the control section stores the encoded moving picture data in a pack string, stores application data of the first file in a pack string and interleaves the above pack strings.

14. The information recording method according to claim 10, wherein the control section stores the encoded moving picture data in a pack string and sets the pack string into a first object unit, stores application data of the first file in a pack string and sets the pack string into a second object unit, and interleaves the first and second object units.

15. An information reproducing method of an information reproducing apparatus which includes an information recording medium which records a first file which contains a multiplexed stream separated by preset units and in which moving picture data encoded in a preset format is multiplexed with application data used to control behavior of a reproduced image of the moving picture data and a second file containing the same data as the application data, means for reading out the multiplexed stream from the recording medium, means for processing the readout multiplexed stream, and storage means, comprising:
demultiplexing the multiplexed stream data into encoded moving picture data and application data, and
reading application data in the second file with reference to additional information contained in the stream in the course of reproduction of the multiplexed stream and supplying the readout data to the storage means.

16. The information reproducing method according to claim 15, further comprising deciding execution and elimination of application data stored in the storage means based on a period of validity when information indicating the period of validity of corresponding application data is contained in the additional information of the header of the application data.

17. The information reproducing method according to claim 15, wherein existing position information of corresponding application data of the second file is described in additional information of the header of the multiplexed moving picture data, and application data of the second file is read out based on the existing position information and the readout data is supplied to the storage means.
